(19) United States
(12) Patent Application Publication
(10) Pub. No.: US 2009/0043731 A1
(43) Pub. Date: Feb. 12, 2009

(54) INFORMATION PROCESSING APPARATUS, AND FUNCTION LIMITATION METHOD OF INFORMATION PROCESSING APPARATUS

(75) Inventor: Masayuki Sato, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/243,441

(22) Filed: Oct. 1, 2008

Related U.S. Application Data
(63) Continuation of application No. PCT/JP2008/056639, filed on Mar. 27, 2008.

(30) Foreign Application Priority Data
Apr. 2, 2007 (JP) 2007-096567

(51) Int. Cl. G06F 7/10; G06F 17/30

(52) U.S. Cl. 707/2; 707/E17.008

(57) ABSTRACT

The present invention aims to limit, in case of causing plural devices to perform a process together, a use of a function of another device by reflecting function limitation information for individual user. In case of retrieving the function of the another device, a function retrieval request is issued to the another device with the set function limitation information for individual user added (S701), and response information for the function retrieval request is acquired from the another device (S702), thereby limiting function selection to the another device.

This application is a continuation of International Application No. PCT/JP2008/056639 filed on Mar. 27, 2008, which claims the benefit of Japanese Patent Application No. 2007-096567 filed on Apr. 2, 2007.

### BACKGROUND OF THE INVENTION

### Field of the Invention

The present invention relates to a function limitation process of an information processing apparatus capable of communicating with another device.

### SUMMARY OF THE INVENTION

Conventionally, there is a case where function retrieval (hereinafter, called service retrieval) is performed from an image forming apparatus which serves as a kind of information processing apparatus to another image forming apparatus so as to use a function of the another image forming apparatus. For example, in case of utilizing a service that image data acquired by reading an original on the own image forming apparatus is transmitted to the another image forming apparatus to cause the another image forming apparatus to process the image data by using the function which cannot be performed by the own image forming apparatus, the function for performing this service is retrieved from the own image forming apparatus. In this regard, there is a case where a specific function is limited for a specific user on the side which retrieves the service (hereinafter, called a service retrieval source). On the other hand, there is a case where the function is not limited to the user by the image forming apparatus on the side to which the service is retrieved (hereinafter, called a service retrieval destination).

In the circumstances, there is a case where the service of the image forming apparatus on the service retrieval destination is retrieved from the image forming apparatus on the service retrieval source.

In this case, there is a case where the service which should not fundamentally be used can be used in the image forming apparatus on the service retrieval source since the function is not limited by the image forming apparatus on the service retrieval destination although the relevant function is limited by the image forming apparatus of the service retrieval source. Such an undesirable circumstance may occur in a case where any function limitation is not considered when the plural image forming apparatuses operate together.

Further, an operation for setting the function limitation to all the apparatuses which can be used by the user is often complicated and troublesome.

Under the circumstances, in case of performing the service retrieval so that the plural apparatuses can perform a predetermined service together, a mechanism for reflecting the function limitation to be set independently for individual user is required.

Conventionally, the patent document 1 has been disclosed to indicate a technique of recognizing a user of an electronic apparatus connected to a network and limiting functions of the electronic apparatus according to the recognized user.

In the patent document 1, a function limiter refers to a user identification unit which identifies a user of a second apparatus capable of communicating with a first apparatus, and an access history table on which a use history of a user to the first apparatus has been recorded.

Further, the function limiter refers to an access history acquisition unit which acquires the use history of the relevant user, and a function limitation reference table on which functions the use of which is permitted according to the use history to the first apparatus have been previously defined.

Then, in the function limiter, a limitation content determination unit determines, based on the use history of the relevant user acquired by the access history acquisition unit, the content of function limitation to the first apparatus to be given to the relevant user.

Consequently, the function limiter can limit the functions of the first apparatus the use of which is permitted to the relevant user, via a main body controller 58 which controls the first apparatus. (Patent Document 1) Japanese Patent Application Laid-Open No. 2003-132029

### SUMMARY OF THE INVENTION

### Problem to be Solved by the Invention

However, the patent document 1 mentions that the function limitation is performed based on the use history of the user, but does not mention any mechanism for acquiring, in case of performing service retrieval, a retrieval result in the state that a function limitation for individual user has been reflected.

For this reason, a conventional problem that, when the service retrieval is performed, unavailable functions are unnecessarily retrieved still remains.

The present invention has been completed to solve the above conventional problem, and an object of the present invention is to provide a mechanism which can acquire, in case of performing a function retrieval so that plural devices perform a process together, a retrieval result in which a function limitation for individual user have been reflected.

### Means for Solving Problem

An image forming apparatus of the present invention, which achieves the above object, is characterized by comprising an information processing apparatus capable of communicating with another device, which comprises: a setting unit adapted to set function limitation information for individual user; a retrieval unit adapted to issue a function retrieval request for the another device with the function limitation information for individual user set by the setting unit added; an acquisition unit adapted to acquire response information for the function retrieval request issued by the retrieval unit; and a display unit adapted to display an acquisition result by the acquisition unit.

Further, a function limitation method of the present invention, which achieves the above object, is characterized by a function limitation method in an information processing apparatus capable of communicating with another device, which the method comprises: a setting step of setting function limitation information for individual user; a retrieval step of issuing a function retrieval request for the another device with the function limitation information for individual user set in the setting step added; an acquisition step of acquiring response information for the function retrieval request issued in the retrieval step; and a display step of controlling a display to display an acquisition result in the acquisition step.

### EFFECT OF THE INVENTION

According to the present invention, it is possible to acquire, in case of performing a function retrieval so as to cause plural devices to perform a process together, a retrieval result in which a function limitation for individual user have been reflected.

### BRIEF DESCRIPTION OF THE DRAWINGS

FIG. 1 is a block diagram illustrating the whole constitution of an image input/output system to which an image forming apparatus according to the first embodiment of the present invention is applicable.

FIG. 2 is a block diagram for describing the function of the control device illustrated in FIG. 1.

FIG. 3 is a diagram for describing the storage region in the hard disk illustrated in FIG. 2.

FIG. 4 is a diagram for describing a data file which exists in the box data region in the hard disk illustrated in FIG. 2, and publishes functions.

FIG. 5 is a diagram for describing the basic screen which is displayed on the display section of the operation unit of each of the first and second image forming apparatuses illustrated in FIG. 1.

FIG. 6 is a diagram for describing the retrieval screen which is displayed on the display section of the operation unit illustrated in FIG. 1.

FIG. 7 is a diagram for describing the scan operation screen which is displayed on the display section of the operation unit illustrated in FIG. 1.

FIG. 8 is a diagram for describing the print completion notification screen which is displayed on the display section of the operation unit illustrated in FIG. 1.

FIG. 9A is a flow chart indicating an example of a first data processing procedure in the image forming apparatus according to the first embodiment.

FIG. 9B is a flow chart indicating the example of the first data processing procedure in the image forming apparatus according to the first embodiment.

FIG. 10 is a block diagram illustrating the whole constitution of an image input/output system to which an image forming apparatus according to the second embodiment of the present invention is applicable.

FIG. 11 is a flow chart indicating an example of a second data processing procedure in the image forming apparatus according to the second embodiment.

FIG. 12 is a flow chart indicating an example of a third data processing procedure in the image forming apparatus according to the third embodiment.

FIG. 13 is a diagram for describing the memory map of a storage medium which stores therein various data processing programs capable of being read by the image forming apparatus according to the present invention.

### DESCRIPTION OF THE EMBODIMENTS

Hereinafter, the best mode for carrying out the present invention will be described in detail with reference to the attached drawings. Here, it should be noted that the dimensions, the materials, the shapes, the relative configurations of the component parts respectively exemplified in the embodiments of the present invention should be properly modified and changed according to the constitution of the apparatus to which the present invention is applied and other various conditions. That is, the present invention is not limited to such exemplifications.

<Description of System Constitution>

### First Embodiment

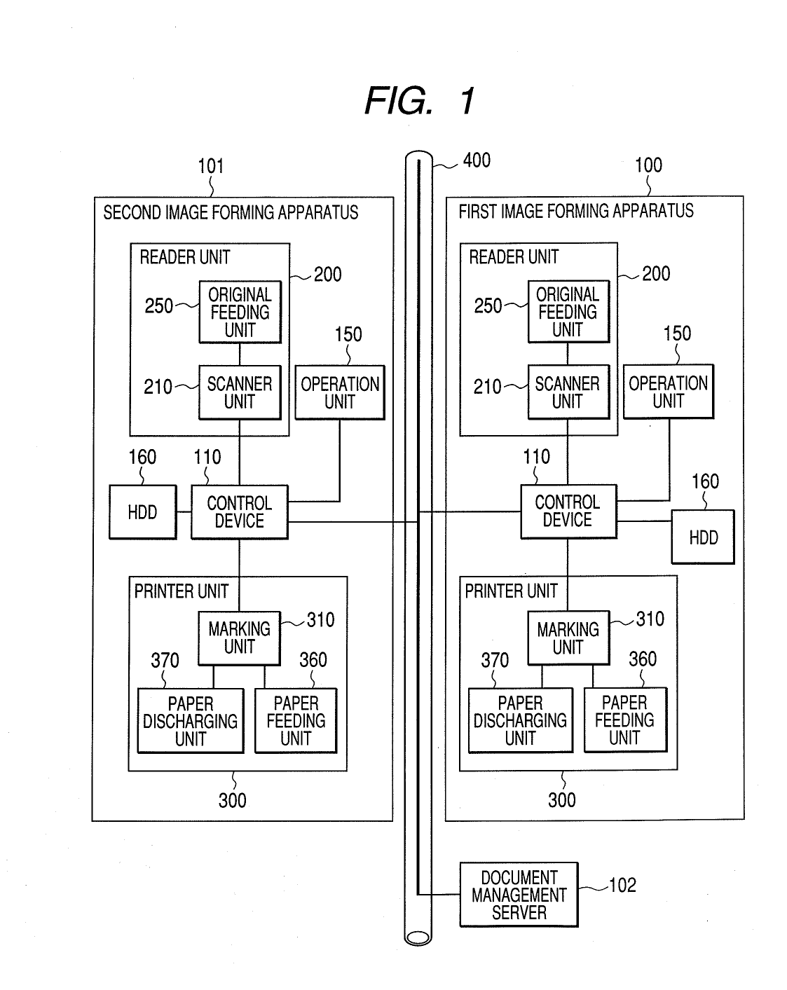

FIG. 1 is a block diagram illustrating the whole constitution of an image input/output system to which an image forming apparatus being one example of an information processing apparatus according to the first embodiment of the present invention is applicable.

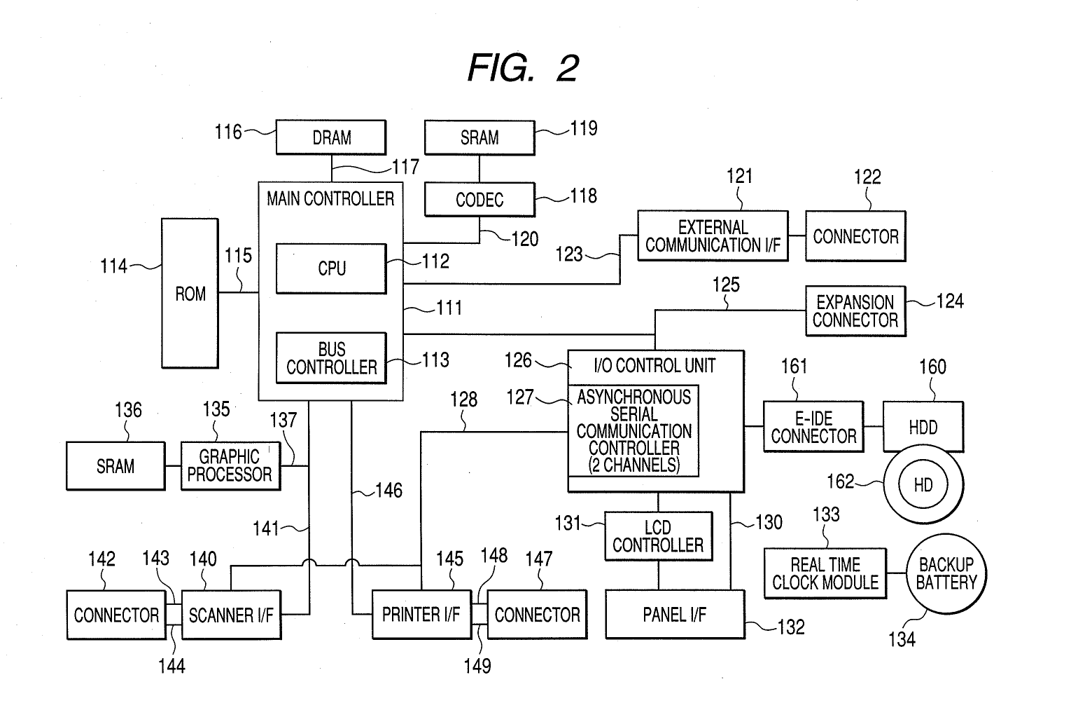

In FIG. 1, a first image forming apparatus 100 is the image forming apparatus which has a specific function, and a second image forming apparatus 101 is the image forming apparatus which does not have the specific function. Here, it is assumed that the specific function is the function for acquiring information by reading a bar code recorded on an original, and retrieving an original electronic document of the relevant original from an HD (hard disk) 162 (later described in FIG. 2) and a document management server 102 on the basis of the acquired information. Of course, the specific function may be another function. Further, in the present embodiment, the two image forming apparatuses, i.e., the first image forming apparatus 100 and the second image forming apparatus 101, are connected to each other via a LAN (local area network) 400. However, the present invention is not limited to this. Namely, three or more image forming apparatuses may be connected mutually, and apparatuses other than the image forming apparatus may be connected mutually.

Furthermore, in the present invention, it is assumed that the “specific function” has been published in the image input/output system and can be used by another apparatus in the system. Incidentally, it should be noted that, since the basic constitution of the first image forming apparatus 100 is the same as that of the second image forming apparatus 101, the same constituent elements between the two image forming apparatuses are denoted by the same reference numeral or symbol, and the description of the same constituent elements will be performed together.

Each of the first image forming apparatus 100 and the second image forming apparatus 101 includes a reader unit (i.e., an image input device) 200, a printer unit (i.e., an image output device) 300, a control device 110, an operation unit 150, and an HDD (hard disk drive) 160.

The reader unit 200, which optically reads an original image and converts the read image into image data, includes a scanner unit 210 having a function for reading an original and an original feeding unit 250 having a function for feeding and transporting an original paper.

The printer unit 300 transports a recording paper, prints the image data as a visible image on the recording paper, and then discharges the recording paper on which the image has been printed outside the apparatus.

The printer unit 300 includes a paper feeding unit 360 having plural kinds of recording paper cassettes, a marking unit 310 having a function for transferring the image data on the recording paper and then fix the transferred image data thereon, and a paper discharging unit 370 for discharging the recording paper on which the image has been printed outside the apparatus. Here, it should be noted that the paper discharging unit 370 may have a sorting function and/or a stapling function.

The control device 110 is electrically connected to the reader unit 200 and the printer unit 300, and is also connected to the LAN 400. The control device 110 controls the reader unit 200 to read the image data of the original, and controls the printer unit 300 to output the read image data to the recording paper, thereby providing a copy function.

Further, the control device 110 provides a scanner function for converting the image data read from the reader unit 200 into code data, and then transmit the acquired code data to a not-illustrated host computer via the LAN 400.

Furthermore, the control device 110 provides a printer function for converting code data received from the host computer via the LAN 400 into image data, and then output the acquired image data to the printer unit 300.

The operation unit 150, which is connected to the control device 110, includes a liquid crystal display unit, a touch panel input device attached on the liquid crystal display unit, and plural hardware keys, thereby providing a user I/F (interface) for operating the image forming apparatuses 100 and 101.

Incidentally, the operation unit 150 may include only a liquid crystal touch panel input device.

(Description of Control Device 110)

FIG. 2 is a block diagram for describing the function of the control device 110 illustrated in FIG. 1.

Here, it should be noted that, in the constitution of the control device 110, the constitution of a later-described graphic processor 135 is different between the first image forming apparatus 100 and the second image forming apparatus 101.

In FIG. 2, a main controller 111 of the control device 110 mainly includes a CPU (central processing unit) 112, a bus controller 113, and various I/F controller circuits.

The CPU 112 and the bus controller 113 control the whole operation of the control device 110, and the CPU 112 operates based on a program read from a ROM (read only memory) 114 via a ROM I/F 115.

An operation for interpreting PDL (page description language) code data received from the host computer and extracting the interpreted data to raster image data has been described as the program. Therefore, the CPU 112 can perform the operation according to software based on the program. The bus controller 113 controls transfer of data input/output from/to respective interfaces. Further, the bus controller 113 performs adjustment when plural buses compete, and also controls DMA (direct memory access) data transfer.

A DRAM (dynamic random access memory) 116, which is connected to the main controller 111 via a DRAM I/F 117, is used as a working area when the CPU 112 operates, and as an area in which the image data are stored.

A codec (coder/decoder) 118 compresses the raster image data stored in the DRAM 116 according to compression technology such as MH (modified Huffman) coding, MR (modified READ (relative element address designate)) coding, MMR (modified modified READ) coding, JBIG (Joint Bi-level Image Experts Group) coding, JPEG (Joint Photographic Experts Group) coding or the like, and contrarily extracts the compressed and stored code data to acquire the raster image data. An SRAM (static random access memory) 119 is used as a temporary working area when the codec 118 operates. The codec 118 is connected to the main controller 111 via an I/F 120, and the data is transferred in the form of the DMA data transfer between the codec 118 and the DRAM 116 under the control of the bus controller 113.

The graphic processor 135, which is connected to the bus controller 113 via an I/F 137 and a scanner bus 141, performs various processes such as an image rotation process, a magnification changing process and the like. Incidentally, in the first embodiment, the graphic processor 135 of the first image forming apparatus 100 further performs a process of extracting, analyzing, generating and embedding bar code information and/or watermark information. An SRAM 136 is used as a temporary working area when the graphic processor 135 operates.

An external communication I/F 121 is connected to the main controller 111 via an I/F 123, and is further connected to an external network by means of a connector 122.

A general-purpose high speed bus 125 is connected to an expansion connector 124 for connecting an expansion board, and is connected to an I/O (input/output) control unit 126. Here, it should be noted that a PCI (Peripheral Components Interconnect) bus is generally used as the general-purpose high speed bus.

An asynchronous serial communication controller 127, which has two channels, is provided in the I/O control unit 126. The asynchronous serial communication controller 127 transmits/receives various communication commands to/from the CPU of each of the reader unit 200 and the printer unit 300.

Further, a scanner I/F 140 and a printer I/F 145 are connected to the I/O control unit 126 via an I/O bus 128.

A panel I/F 132, which is connected to an LCD (liquid crystal display) controller 131, includes an interface for performing display on the liquid crystal display unit on the operation unit 150 and a key input I/F 130 for inputting data from the hardware keys and the touch panel keys.

A signal input from the operation unit 150 is transferred to the CPU 112 of the main controller 111 via the panel I/F 132, and the image data transferred from the panel I/F 132 is displayed on the liquid crystal display unit of the operation unit 150. Here, on the liquid crystal display unit, also the functions, the image data and the like in the operations of the first image forming apparatus 100 and the second image forming apparatus 101 are displayed.

A real time clock module 133, which is backed up by a backup battery 134, is used to update and store the dates and the times which are managed in the apparatus.

An E-IDE (Enhanced Integrated Drive Electronics) connector 161 is used to connect an external memory. In FIG. 1, the HDD 160 is connected to the apparatus via the E-IDE connector 161, thereby storing the image data in the HD 162 and reading the image data from the HD 162. Of course, a known external memory other than the HD may be connected to the E-IDE connector 161.

A connector 142 and a connector 147 are connected respectively to the reader unit 200 and the printer unit 300. Further, the connector 142 is connected to the scanner I/F 140 via an asynchronous serial I/F 143 and a video I/F 144, and the connector 147 is connected to the printer I/F 145 via an asynchronous serial I/F 148 and a video I/F 149.

The scanner I/F 140 is connected to the reader unit 200 via the connector 142, and is also connected to the main controller 111 via the scanner bus 141. Besides, the scanner I/F 140 has a function for performing a predetermined process to the image data received from the reader unit 200. Also, the scanner I/F 140 has a function for outputting a control signal generated based on the video control signal transferred from the reader unit 200 to the scanner bus 141.

Incidentally, the data transfer from the scanner bus 141 to the DRAM 116 is controlled by the bus controller 113.

The printer I/F 145 is connected to the printer unit 300 via the connector 147, and is also connected to the main controller 111 via a printer bus 146. Besides, the printer I/F 145 has a function for performing a predetermined process to the image data output from the main controller 111, and output the processed image data to the printer unit 300.

Also, the printer I/F 145 has a function for outputting a control signal generated based on the video control signal transferred from the printer unit 300 to the printer bus 146. Incidentally, the raster image data extracted on the DRAM 116 is transferred in the form of the DMA data transfer to the printer unit 300 under the control of the bus controller 113 via the printer bus 146 and the video I/F 149.

In the present embodiment, a retrieval sequence of an original electronic document is performed by the first image forming apparatus 100 based on the program stored in the ROM 114.

The first image forming apparatus 100 analyzes, by using the graphic processor 135, the bar code portions and/or the electronic watermark portions of the image data of the original read by the reader unit 200 and the image data of the original transferred from the second image forming apparatus 101, and thus acquires address information. Then, the first image forming apparatus 100 acquires the original electronic document stored in the later-described HD 162 or the document management server 102, according to the address information.

(Description of Storage Region)

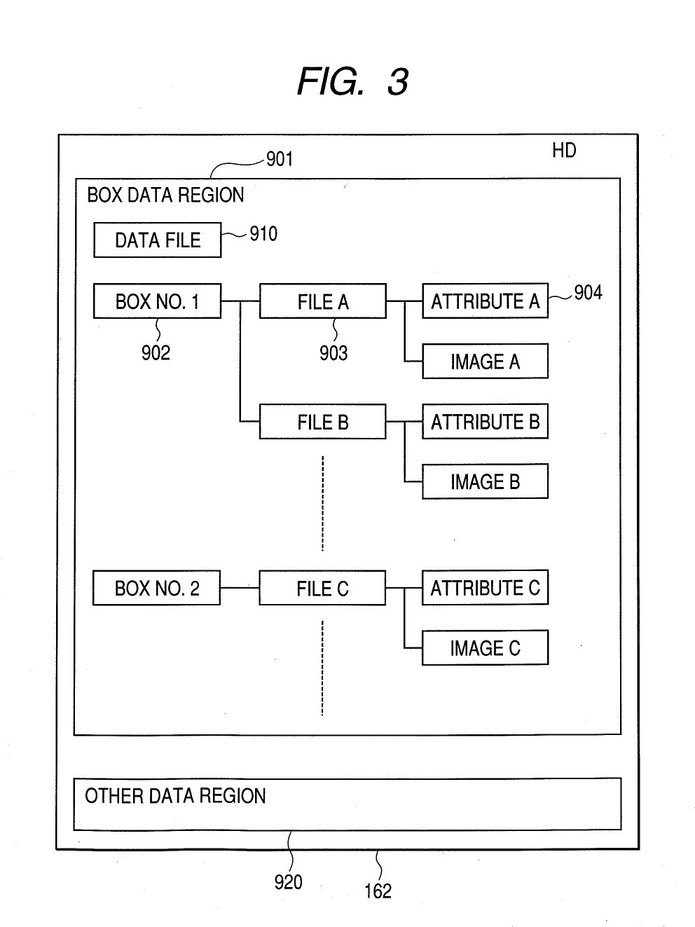

FIG. 3 is a diagram for describing the storage region in the HD 162 illustrated in FIG. 2.

In FIG. 3, a box data region 901 is the region in which the image data acquired by reading the original by the reader unit 200 and the image data received via the LAN 400 are stored. Also, later-described original data is stored in the box data region 901.

Further, data 902 indicates a box, and the box data region 901 totally includes N boxes (No. 1 to No. N). Data 903 indicates a file included in the box, and plural files can be stored in one box. Further, the one file includes data 904 indicating an attribute of the file (hereinafter called an attribute) and image data (image). The attribute 904 includes various information such as a resolution, a size, color/monochrome and the like of the image data (image). A data file 910 indicates the function which is published in the system according to the present embodiment. More specifically, the information of the function published in the system is described in the data file 910. A data region 920 is the data region other than the box data region.

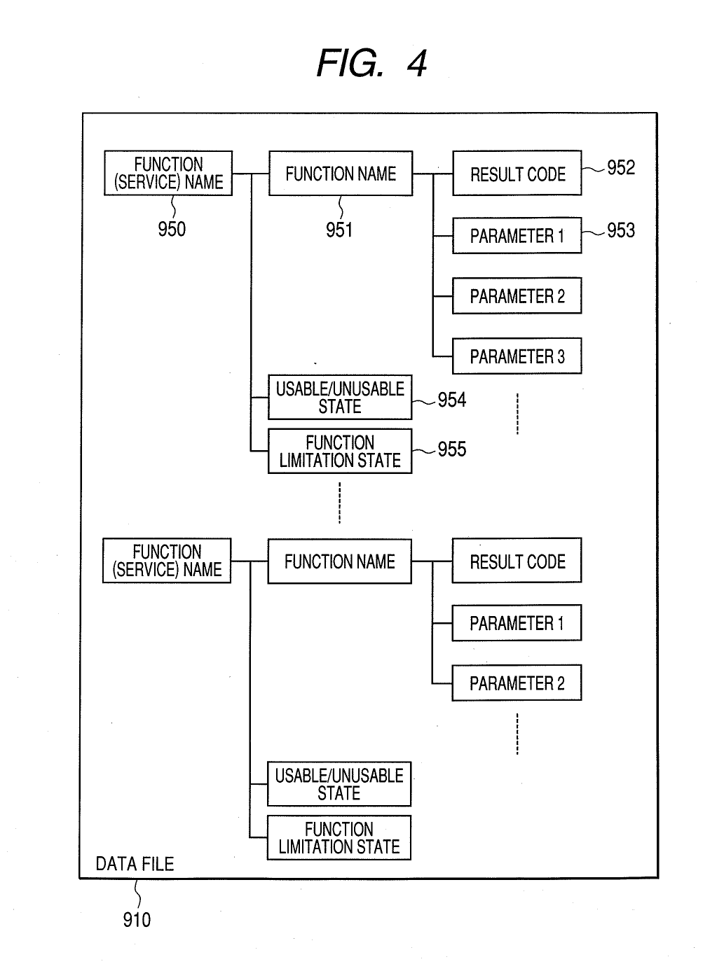

FIG. 4 is a diagram for describing the data file 910 which exists in the box data region in the HD 162 illustrated in FIG. 2, and publishes the functions.

In FIG. 4, data 950 indicates a name of the function (service) (called “function (service) name”) which is published, and data 951 indicates a name of a function (functional formula) (called “function name”) which is used to perform the function. Code data 952 indicates a result code in the function (functional formula). That is, the code data 952 is returned to the side of using the function (service). Code data 953 indicates a parameter in the function (functional formula) which is used to perform the function (functional formula). A flag 954 indicates whether or not the relevant function is in an available (usable) state. That is, if the flag 954 indicates that the relevant function (service) is not in the available state, the relevant function (service) cannot be used. A flag 955 indicates whether or not a use of the function (service) should be limited for individual user. That is, if the flag corresponding to the user who requested a use of the function (service) is not available, the relevant function (service) cannot be used.

(Description of Operation Unit)

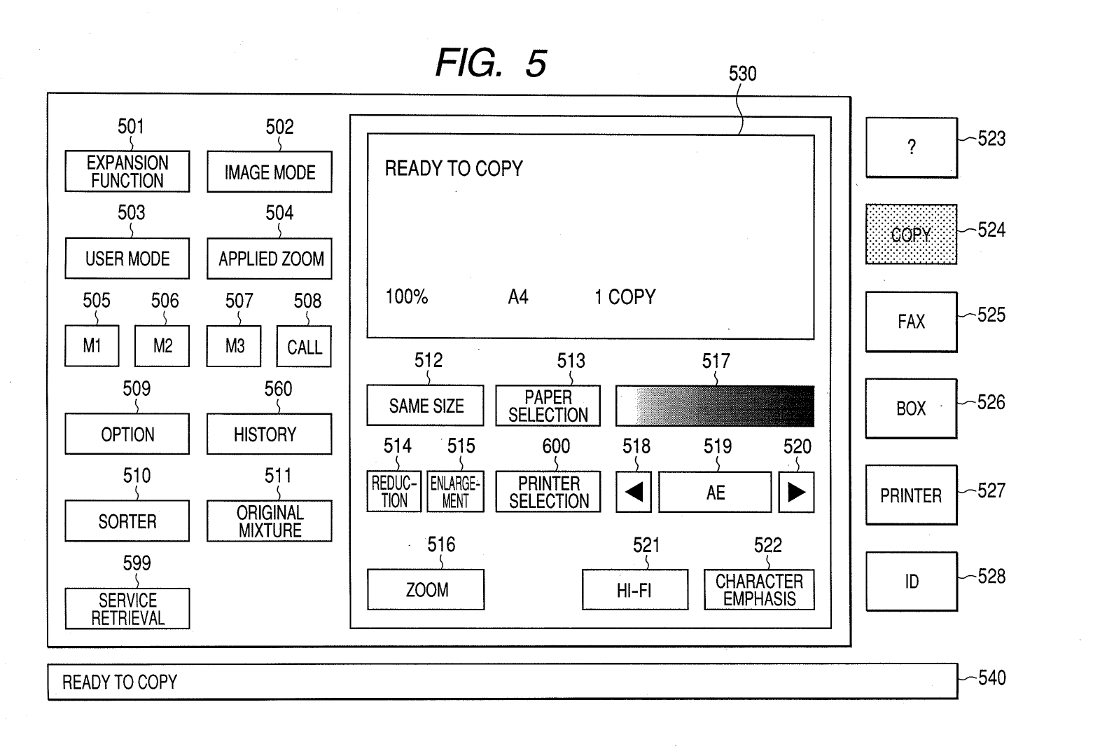

FIG. 5 is a diagram for describing the basic screen which is displayed on the display section of the operation unit 150 of each of the first image forming apparatus 100 and the second image forming apparatus 101 illustrated in FIG. 1.

Incidentally, the relevant screen is a touch panel screen. Therefore, if the displayed area surrounded by the frame of the function is touched, the relevant function is performed.

In FIG. 5, when a copy mode key 524 is depressed, a copy operation is performed. Further, when the copy mode key 524 is depressed, a copy mode screen 530 is displayed. When an expansion function key 501 is depressed, a mode of setting double-sided copy, multiple copy, shift, binding margin, frame canceling, and the like is set.

A status line 540 displays a message indicating a state of the apparatus, print information and the like. In FIG. 5, the status line 540 indicates that the apparatus is in a state of waiting for a copy start instruction.

An image mode key 502 is the key for setting a mode of performing halftone dot meshing, shadowing, trimming and masking processes to a copy image. A user mode key 503 is the key for registering a mode memory, and setting a standard mode screen.

An applied zoom key 504 is the key for setting a mode of performing magnification changing independently to X and Y directions of an original, and a zoom program mode for calculating a magnifying power based on an original size and a copy size.

Further, an M1 key 505, an M2 key 506 and an M3 key 507 are the keys for respectively calling the registered mode memories. An option key 509 is the key for setting an option function such as a film projector function or the like so as to copy an image directly from a film. A call key 508 is the key for performing a call.

A sorter key 510 is the key for setting a sort copy operation, a non-sort copy operation and a group copy operation. An original mixture key 511 is the key which is depressed when originals of different sizes are together set to the original feeder. For example, when originals of A4 size and A3 size are mixedly set, or when originals of B5 size and B4 size are mixedly set, the original mixture key is depressed.

A same size key 512 is the key for setting a copy magnification to 100%, a reduction key 514 is the key for performing defined reduction copy, and an enlargement key 515 is the key for performing defined enlargement copy. A zoom key 516 is the key for performing an operation to set an arbitrary magnifying power.

A paper selection key 513 is the key for selecting a kind of copy paper. Every time a density key 520 is depressed, a copy density gradually increases. On the other hand, every time a density key 518 is depressed, the copy density gradually decreases.

A density display section 517 includes an indicator which moves rightward in response to the depression of the density key 520 and moves leftward in response to the depression of the density key 518. An AE (automatic exposure) key 519 is the key for instructing a process to copy an original having a dark background such as a newspaper or the like by performing automatic density adjustment.

A hi-fi (high fidelity) key 521 is the key for copying an original of which the halftone density is high such as a photographic original. A character emphasis key 522 is the key for instructing a process of emphasizing characters in a character original.

A history key 560 is the key for displaying history information of a print-ended job. For example, if the history key 560 is depressed, the information indicating an end hour, a user name, a file name, print number and the like of a print job is displayed.

A guide key 523 is the key for displaying guidance of keys. A user depresses the guide key 523 when he/she does not know a function of a certain key.

A fax key 525 is the key for confirming facsimile transmission and facsimile reception.

A box key 526 is the key for displaying a screen indicating a box function. A printer key 527 is the key for changing a print density, or referring to print output detailed information of the PDL data received from the remotely located host computer. An ID (identification) key 528 is the key for inputting user authentication information to specify a user who uses the image forming apparatus.

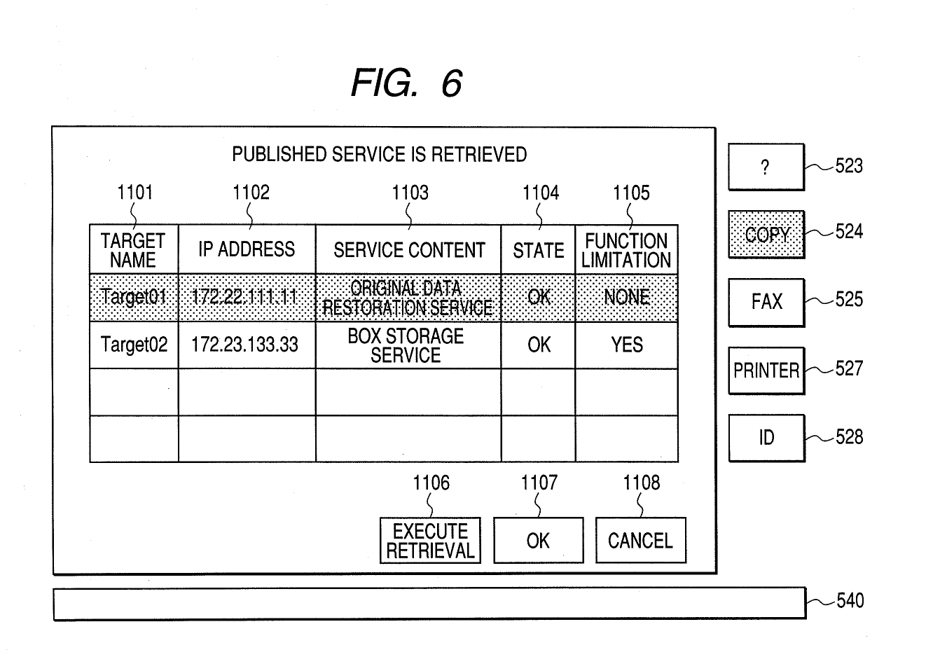

A service retrieval key 599 is the key for retrieving the functions (services) which have been published by the plural apparatuses on the LAN 400. When the service retrieval key 599 is depressed, a screen illustrated in FIG. 6 is displayed.

FIG. 6 is a diagram for describing the retrieval screen which is displayed on the display section of the operation unit 150 illustrated in FIG. 1. Here, it should be noted that the retrieval screen illustrated in FIG. 6 is displayed when the service retrieval key 599 illustrated in FIG. 5 is depressed.

In FIG. 6, it is possible, by depressing a retrieval execution key 1106, to retrieve, from among the apparatuses connected on the LAN 400, the apparatus (target) of which the functions (services) have been published and the contents of the relevant functions (services).

At this conjuncture, the image forming apparatus acting as the retrieval source transmits function limitation information as well as a retrieval request, and acquires as a retrieval result the function (service) according to the transmitted function limitation information. In other words, the image forming apparatus acting as the retrieval source acquires, by transmitting the function limitation information, the retrieval result in the state that a service which is unavailable due to the function limitation has been eliminated from response information returned in regard to the retrieval request.

Here, it is assumed that the function limitation information has been registered for individual user in the HDD 160 of the image forming apparatus acting as the retrieval source in response to an instruction from the operation unit 150, the document management server 102 or the like of the image forming apparatus. However, as described in later for another embodiment, the function limitation information may not be registered in the image forming apparatus acting as the retrieval source but may be registered in the image forming apparatus and the management server on the service publishing side. In this case, when the retrieval request is transmitted from the image forming apparatus acting as the retrieval source, the function limitation information is not transmitted together but information capable of identifying the user is transmitted. Thus, the image forming apparatus on the service publishing side returns a response in which the function limitation information has been reflected.

Further, when the retrieval request is transmitted from the image forming apparatus acting as the retrieval source, the information capable of identifying the user may not be transmitted. Then, in the whole acquired retrieval result, the retrieval result in which the function limitation information has been reflected may be displayed.

Furthermore, the function limitation information may be, instead of the information for limiting the use by the user, the information capable of identifying information that the user is permitted to use. In this case, the use of the function other than the function that the user is permitted to use is limited.

Furthermore, a data format of the function limitation information is not limited if the content of the service and the state of the function limitation can be discriminated.

Incidentally, if a user is authenticated by inputting a user ID being user authentication information capable of specifying the user to the image forming apparatus, the function limitation information corresponding to the input user ID is read. Then, when the function is retrieved, the function retrieval request including the function limitation information read based on the user ID is transmitted to the LAN 400. Subsequently, the image forming apparatus which publishes the function thereof refers to the function limitation information included in the retrieval request transmitted. Here, if the relevant image forming apparatus publishes the function which should not be limited, the relevant image forming apparatus returns the response information including the relevant function. Thus, in case of causing the plural image forming apparatuses to perform the function process together, it is possible to prevent the function to which the user who uses the image forming apparatus being a cooperation partner does not have use authority from being used. Likewise, if it is controlled not to list up the image forming apparatus to which the user who uses the image forming apparatus being the cooperation partner does not have the use authority, it enables the user to select the image forming apparatus corresponding to the relevant function.

If a response in regard to the retrieval request transmitted in response to the depression of the retrieval execution key 1106 is returned, the retrieval result as illustrated in FIG. 6 being the acquisition result is displayed as the list. Here, a column 1101 in the list indicates target names, each of which displays a name set to the image forming apparatus which publishes the relevant service. A column 1102 in the list indicates IP addresses of the targets, each of which displays the IP address of the relevant image forming apparatus. A column 1103 in the list indicates service contents, each of which displays the content of the relevant service. A column 1104 in the list indicates states of the services, each of which displays whether or not the relevant service is in an available state. A column 1105 in the list indicates states of the function limitations, each of which displays whether or not the relevant function is the function to which a function limitation has been set. For example, in FIG. 6, since the function limitation in the original data restoration service is “none”, all the functions of this service can be used without any limitation. On the other hand, since the function limitation in the box storage service is “yes”, the functions of this service are partially limited. In the latter case, for example, it is conceivable that the size of storable data for a specific user is limited to a predetermined size. Besides, if the function of the original data restoration service is limited, for example, it is conceivable that, for a specific user (or to users other than the specific user), a part of an original is masked and then output or a color original is output in monochrome. Incidentally, the column 1105 may not be provided in the list.

If a position on any row in the list is depressed, the function (service) displayed in the relevant row is in a displaying state (that is, the displaying state of this selected row is made different from those of other rows). Then, such selection is determined if an OK key 1107 is depressed, whereby the user can visibly and clearly discriminate the selected service.

Further, if a cancel key 1108 is depressed, the service retrieval itself is canceled, and the display screen on the operation unit 150 is returned to the basic screen illustrated in FIG. 5.

In the present embodiment, the function limitation information is set for each user ID. However, it is of course unnecessary to set the user ID for each user. That is, it is possible to set the user ID for a specific group.

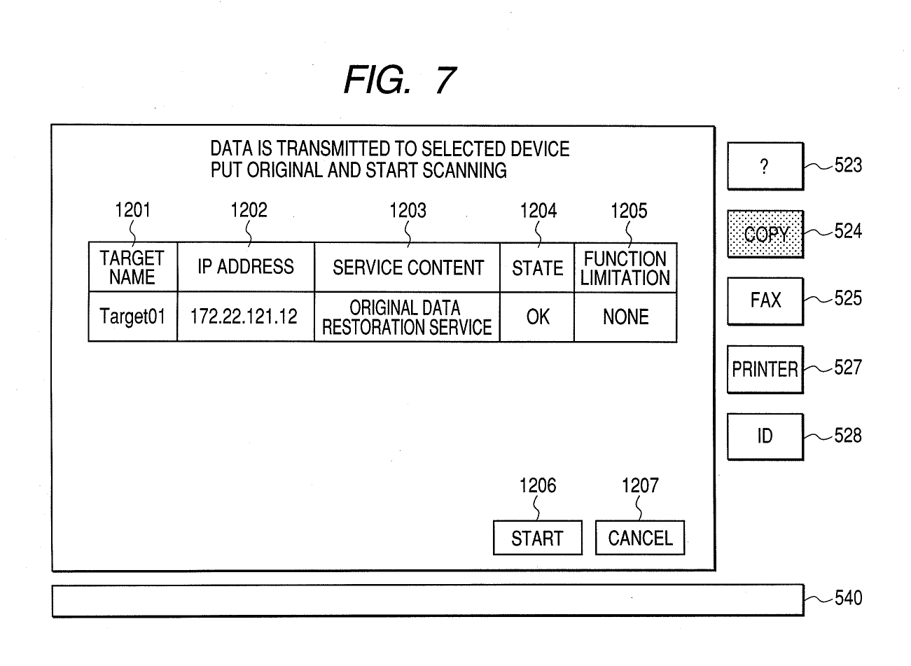

FIG. 7 is a diagram for describing the scan operation screen which is displayed on the display section of the operation unit 150 illustrated in FIG. 1. In the present embodiment, the screen illustrated in FIG. 7 is displayed on the operation unit 150 if the original data restoration service is selected by the user on the service retrieval screen illustrated in FIG. 6. Here, it should be noted that the original data restoration service is the service for acquiring original data by reading information such as a bar code or the like specifying the original data added to an original by the reader unit 200. To achieve original data restoration service, it is necessary to store the original data in a box, convert the information capable of specifying the storage position of the original data and a file into a bar code or the like, add the acquired bard code or the like to the image data, and then print the acquired image data by the printer unit 300. Then, the original to which the information such as the bard code or the like has been added is read by the reader unit 200, thereby specifying and outputting the original data from the bard code or the like. By reading the original in this manner, the original data corresponding to the read original is acquired, whereby the original data can be acquired even from the original including handwritten matters or the like.

Incidentally, the reason why the scan operation screen is displayed in FIG. 7 is that the service selected in FIG. 6 is the service in which scanning of the original is performed. In this connection, if the service selected in FIG. 6 is the service in which scanning of the original is not performed by the image forming apparatus 101, the scan operation screen is not displayed, but another screen corresponding to the selected service is displayed.

In FIG. 7, a target name is displayed in a column 1201, an IP address of a target is displayed in a column 1202, a service content is displayed in a column 1203, a state of a service is displayed in a column 1204, and a state of function limitation is displayed in a column 1205.

Here, if an original that the user intends to restore its original data is put on the original feeding unit 250 and a start key 1206 is depressed, the scanner unit 210 starts to scan the original. Here, if the original data restoration service is performed from the second image forming apparatus 101 which does not have the function corresponding to the original data restoration service, the image data of the scanned original is transmitted from the second image forming apparatus 101 to the first image forming apparatus 100. Then, the first image forming apparatus 100, which received the image data, extracts from the received image data the information such as the bar code or the like for specifying the position where the original data has been stored and the file which includes the original data. Subsequently, on the basis of the extracted information, the first image forming apparatus 100 specifies the original data stored in the box and returns the specified original data to the second image forming apparatus 101.

On the other hand, if the original data restoration service is performed by the first image forming apparatus 100 which can perform the original data restoration service, the image data of the scanned original is transmitted from the reader unit 200 to the control device 110 in the first image forming apparatus 100 itself, and the bar code portion is extracted to retrieve the original data stored in the box. Further, if a cancel key 1207 is depressed without depressing the start key 1206, the relevant function itself is canceled, and the screen illustrated in FIG. 7 returns to the screen illustrated in FIG. 6.

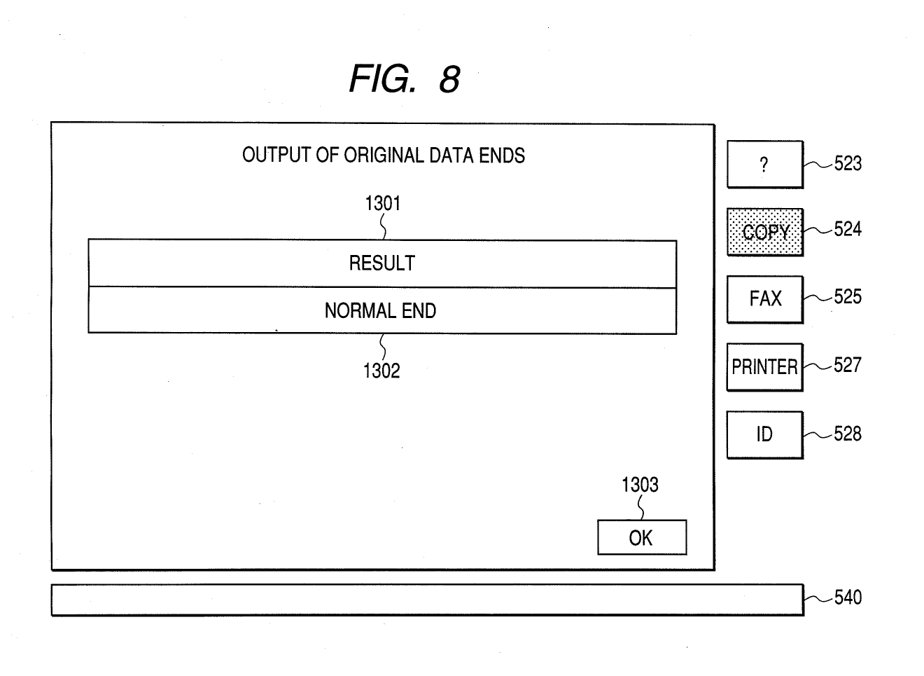

FIG. 8 is a diagram for describing the print completion notification screen which is displayed on the display section of the operation unit 150 illustrated in FIG. 1. The screen exemplarily illustrated in FIG. 8 is displayed on the operation unit 150 of the second image forming apparatus 101 in a case where the image data is transmitted from the second image forming apparatus 101 to the first image forming apparatus 100, the original data is retrieved by the first image forming apparatus 100 based on the transmitted image data, and then the acquired original data is printed by the second image forming apparatus 101.

The screen illustrated in FIG. 8 indicates the state that the operation of retrieving and outputting the original data normally ends. More specifically, in this case, a text message “normal end” is displayed in a row 1302 in regard to “result” displayed in a row 1301. On the other hand, if the operation does not normally end, the fact that an error occurs and its reason or the like are displayed in the row 1302. Here, if an OK key 1303 is depressed, the display screen illustrated in FIG. 8 is returned to the basic screen illustrated in FIG. 5.

(Description of Operation of Specific Function)

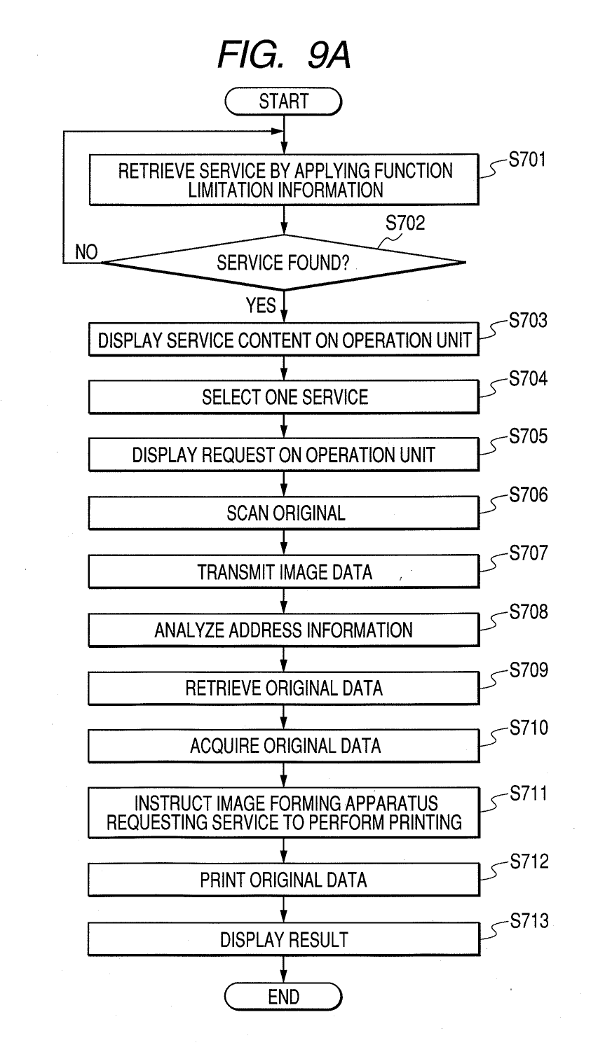

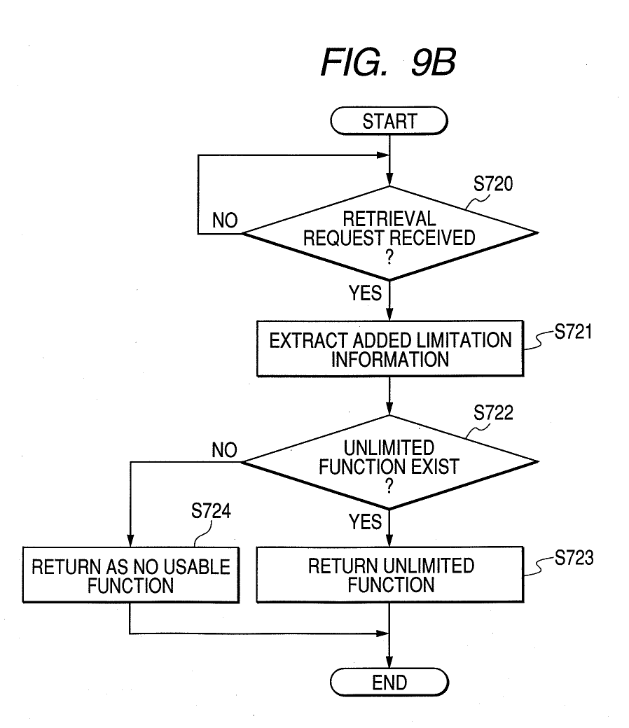

Subsequently, a procedure in which one of the image forming apparatuses in the first embodiment utilizes the specific function (service) of the other of the image forming apparatuses will be described with reference to flow charts illustrated in FIGS. 9A and 9B.

FIGS. 9A and 9B are the flow charts both indicating an example of a first data processing procedure in the image forming apparatus according to the first embodiment. Here, such an example of service process as in the flow charts of FIGS. 9A and 9B corresponds to an original data retrieval output process. Further, it should be noted that the flow chart of FIG. 9A corresponds to the process of the second image processing apparatus 101 and the flow chart of FIG. 9B corresponds to the process of the first image forming apparatus 100.

Incidentally, the flow chart of FIG. 9A includes steps S701 to S713 and the flow chart of FIG. 9B includes steps S720 to S724, and the process in each step is achieved if the CPU 112 illustrated in FIG. 2 loads the control program stored in the ROM 114 or the HD 162 to the DRAM 116 and then performs the loaded control program.

Initially, before the first data processing procedure starts, a user has to depress the ID key 528 (FIG. 5) and then input user authentication information to specify the function limitation information corresponding to the user authenticated by the input user authentication information. Subsequently, if the service retrieval key 599 is depressed by the user on the basic screen of FIG. 5, and further the retrieval execution key 1106 is depressed by the user on the service retrieval screen of FIG. 6, the first data processing procedure starts. Here, it should be noted that the service is not limited to the original data restoration service. That is, the present invention is applicable to any service if it can be provided in the image forming apparatus. In the present embodiment, the service process based on the retrieval operation by the user of the second image forming apparatus 101 is described.

Initially, in S701, as illustrated in FIG. 6, it is requested to retrieve the functions (services) provided (published) in the image input/output system connected to the LAN 400.

More specifically, the second image forming apparatus 101 which does not have the original data restoration service transmits a predetermined retrieval packet, which includes a retrieval request of the published function and function retrieval information, to a broadcasting address. Here, the retrieval packet may not be transmitted from the second image forming apparatus 101 to the broadcasting address. That is, the retrieval packet may be transmitted to a retrieval server which is separately provided on the LAN 400.

Then, in FIG. 9B, if the retrieval packet transmitted from the second image forming apparatus 101 is received by the first image forming apparatus 100 in S720, the function limitation information of the request source (the second image forming apparatus 101), which has been added to the received retrieval packet, is extracted in S721. Then, in S722, it is discriminated by the CPU 112 of the first image forming apparatus 100 whether or not, among the functions which have been published by the first image forming apparatus 100, the function which is not limited by the extracted function limitation information exists. Here, if it is discriminated by the CPU 112 of the first image forming apparatus 100 that the function which is not limited by the extracted function limitation information exists, in S723, response information which indicates the not limited function is returned to the second image forming apparatus 101 being the request source. Then, the process ends.

On the other hand, if it is discriminated by the CPU 112 of the first image forming apparatus 100 in S722 that the function which is not limited by the extracted function limitation information does not exist, in S724, response information which indicates that there is no usable (available) function is returned to the second image forming apparatus 101 being the request source. Then, the process ends. Here, in this case, the response information may not be returned to the second image forming apparatus 101. Instead, no response may be transmitted to the second image forming apparatus 101.

The response information which is returned from each apparatus including the first image forming apparatus 100 includes the information capable of identifying the function to which any function limitation is not set and the relevant apparatus (that is, each apparatus including the first image forming apparatus 100). Therefore, the second image forming apparatus 101 can know, based on the response information returned from each image forming apparatus on the network, the image forming apparatus having a certain service and the kind of relevant service.

Here, it should be noted that an apparatus which has a service capable of being published is not limited to the image forming apparatus. That is, also a personal computer, to which software for providing the service has been installed, or the like may be used.

Next, in S702 of FIG. 9A, it is discriminated by the CPU 112 of the second image forming apparatus 101 whether or not the published service is found. That is, it is discriminated by the CPU 112 of the second image forming apparatus 101 whether or not the response information including the usable function is received in regard to the function (service) retrieval request. In any case, if it is discriminated by the CPU 112 of the second image forming apparatus 101 that the published service is not found, the flow returns to S701.

On the other hand, in S702, if it is discriminated by the CPU 112 of the second image forming apparatus 101 that the published service is found, the flow advances to S703 to display, on the operation unit 150, the retrieval result which indicates the contents of the usable services as illustrated in FIG. 6.

Incidentally, after the second image forming apparatus 101 requested the service retrieval, it is discriminated in response to the response information returned from the first image forming apparatus 100 whether or not to permit each of all the usable services. Then, if a not-permitted matter is partially included in the usable service, the message “yes” is displayed in the column 1105 on the screen illustrated in FIG. 6. That is, if the function limitation in the column 1105 is displayed as “yes”, the user can basically use the relevant service itself, but he/she has to know there is at least one limited matter in the relevant service. For example, it is conceivable that a processible data size is limited, or that a data format is limited.

In a case where the retrieval result is displayed, the function limitation information stored in the DRAM 116 and the function included in the response information are further compared with each other. Then, if the function to which the function limitation has been set is included in the response information, the relevant function is deleted. Thus, even if the function to which the function limitation has been set is erroneously included in the response information, the content of the function limitation information can be reflected.

Then, if one of the services in the list illustrated in FIG. 6 is selected on the operation unit 150 of the second image forming apparatus 101 in S704, such a request screen (scan operation screen) as described in FIG. 7 is displayed in S705. Then, if an original is put on the original feeding unit 250 and the start key 1206 is depressed by a user, scanning of the put original is started by the scanner unit 210 of the second image forming apparatus 101 in S706.

Subsequently, in S707, the image data acquired by the scanning is transmitted via the LAN 400 to the first image forming apparatus 100 which is the service providing source. In the present embodiment, as described above, it is assumed that the original data restoration service by the first image forming apparatus 100 has been selected as illustrated in FIG. 6.

In S708, the first image forming apparatus 100 analyzes a bar code or an electronic watermark included in the image data received from the second image forming apparatus 101 via the LAN 400 to acquire the address information indicating the storage position of the original data. Here, such an analyzing process is performed by the graphic processor 135.

Then, in S709, based on the acquired address information, the first image forming apparatus 100 retrieves the original data from the hard disk of the first image forming apparatus 100 itself, the hard disk of the second image forming apparatus 101 and had disks of not-illustrated other image forming apparatuses, and the document management server 102. At that time, if the relevant document is found, the retrieved original data is acquired in S710.

Next, in S711, a print instruction is issued from the image forming apparatus (the first image forming apparatus 100) which provides the service to the image forming apparatus (the second image forming apparatus 101) which requests the service.

Subsequently, the original data is printed by the second image forming apparatus 101 in S712, the result illustrated in FIG. 8 is screen-displayed on the operation unit 150 of the second image forming apparatus 101 in S713, and then the process ends.

Incidentally, after the original data was retrieved by the first image forming apparatus 100 in S709, the original data may be acquired in S710 and then printed by the first image forming apparatus 100 in S712.

In this case, the information indicating that the operation normally ended is transmitted from the first image forming apparatus 100 to the second image forming apparatus 101 in S713. Consequently, the second image forming apparatus 101 detects that the original data restoration service normally ended, and thus displays the screen as illustrated in FIG. 8.

According to the first embodiment, in the case where the image forming apparatus having a specific function is retrieved from the image forming apparatus not having the specific function, it is possible to provide the system which controls whether or not to be able to provide the service by applying the function limitation information registered in the retrieval request source.

Consequently, it is possible to surely limit the unfavorable situation that the service which should not originally be used can be used by the image forming apparatus being the retrieval destination because the function limitation to a specific user is not set to the image forming apparatus being the retrieval destination although the function limitation to the specific user is set to the image forming apparatus being the retrieval source.

### Second Embodiment

In the second embodiment, a case where, when the function for acquiring original data is used, the function limitation information is acquired from a function limitation information storage server because there is no function limitation information in any image forming apparatus will be described.

In the first embodiment, when the second image forming apparatus issues the function (service) retrieval request, the second image forming apparatus sends the function limitation information stored in the second image forming apparatus itself, together with the function retrieval request. On the other hand, in the second embodiment, the function limitation information is not stored in the second image forming apparatus 101 itself. Namely, the function limitation information is acquired and used from the newly provided function limitation information storage server. In the following, the process in the second embodiment will be described in detail.

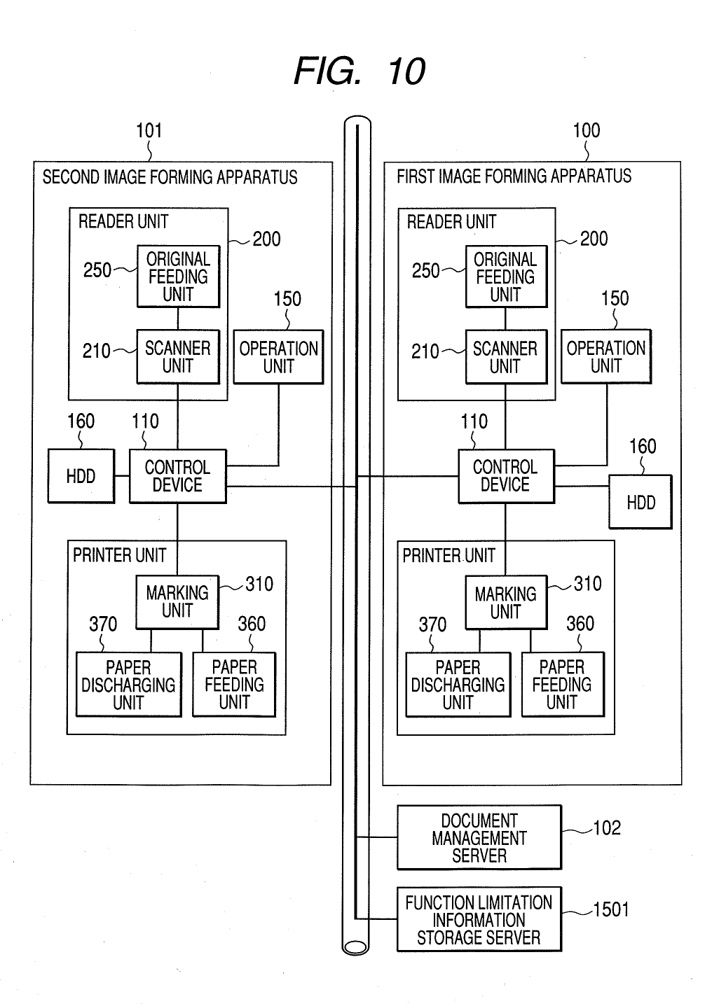

First, the whole constitution of an image input/output system according to the second embodiment will be described with reference to FIG. 10.

FIG. 10 is a block diagram illustrating the whole constitution of the image input/output system to which the image forming apparatus according to the second embodiment of the present invention is applicable. As illustrated in FIG. 10, the constitution of the second embodiment is different from the constitution of the first embodiment in the point that a function limitation information storage server 1501 is provided on the LAN 400.

The function limitation information storage server 1501 is the device in which the function limitation information for each user used in the second image forming apparatus 101 is stored. Further, the function limitation information storage server 1501 is accessible from various devices on the LAN 400. More specifically, if the device which accessed the function limitation information storage server 1501 transmits user authentication information for specifying a user, the function limitation information storage server 1501 returns the function limitation information according to the relevant user. In FIG. 10, the constituent elements other than the function limitation information storage server 1501 are the same as those in the first embodiment illustrated in FIG. 1, whereby the description of these elements will be omitted here.

(Description of Operation of Specific Function)

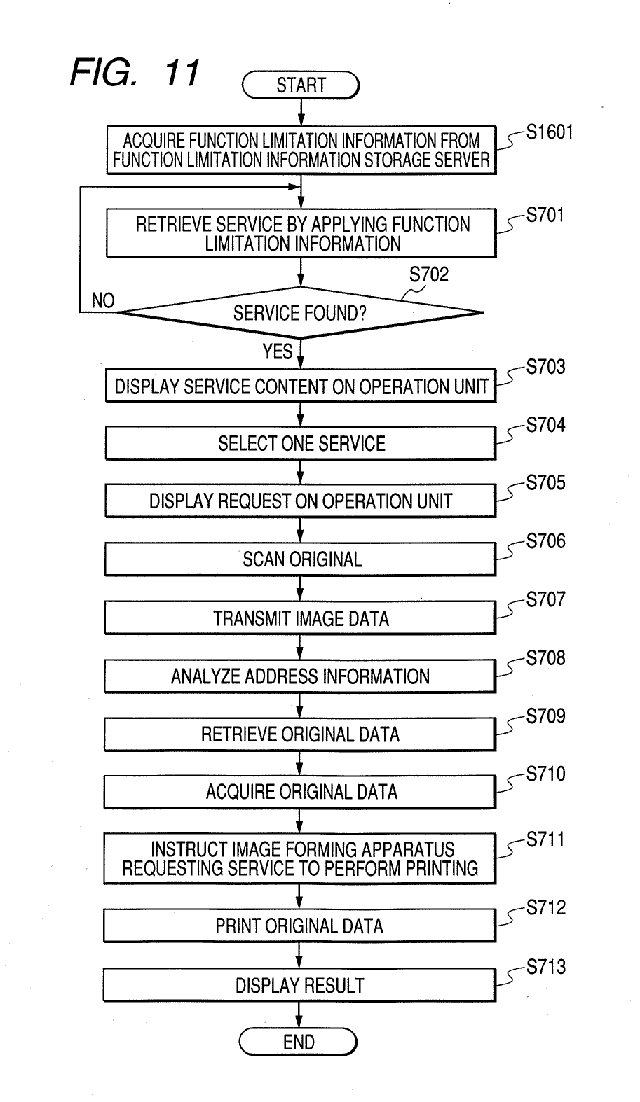

FIG. 11 is a flow chart indicating an example of a second data processing procedure in the image forming apparatus according to the second embodiment. The flow chart of FIG. 11 includes steps S701 to S713 and S1601. Incidentally, the same processes as those in the first embodiment illustrated in FIG. 9A are indicated by the same reference numerals respectively, and the description thereof will be omitted.

In S1601, the second image forming apparatus 101 transmits the user authentication information input from the operation unit 105 by the user after depression of the ID key 528 to the function limitation information storage server 1501. Consequently, the function limitation information of the user corresponding to the user authentication information is acquired from the function limitation information storage server 1501. The acquired function limitation information is stored in the DRAM 116 of the second image forming apparatus 101. Here, the following steps are respectively the same as the corresponding steps illustrated in FIGS. 9A and 9B, whereby the description thereof will be omitted.

According to the second embodiment, the function limitation information for each user is stored in the function limitation information storage server 1501, and the stored function limitation information is received and used by the second image forming apparatus 101 when needed. Consequently, even if the function limitation information is not prepared previously in the second image forming apparatus 101, the retrieval result of the function to which the latest function limitation information is applied can be acquired when retrieving the function (service). Moreover, by operating an arbitrary image forming apparatus capable of communicating with the function limitation information storage server, the process to which the function limitation information is applied can be performed.

### Third Embodiment

In the above-described second embodiment, since the function limitation information is not stored in the second image forming apparatus 101 that the user operates, the second image forming apparatus 101 acquires and uses the function limitation information from the function limitation information storage server 1501. On the other hand, in the third embodiment, the first image forming apparatus 100 on the service providing side acquires the function limitation information from the function limitation information storage server 1501, and applies the acquired function limitation information to a service retrieval result. In the following, the process in the third embodiment will be described in detail.

Here, the whole constitution of an image input/output system according to the third embodiment is the same as that illustrated in FIG. 10, whereby the description thereof will be omitted.

(Description of Operation of Specific Function)

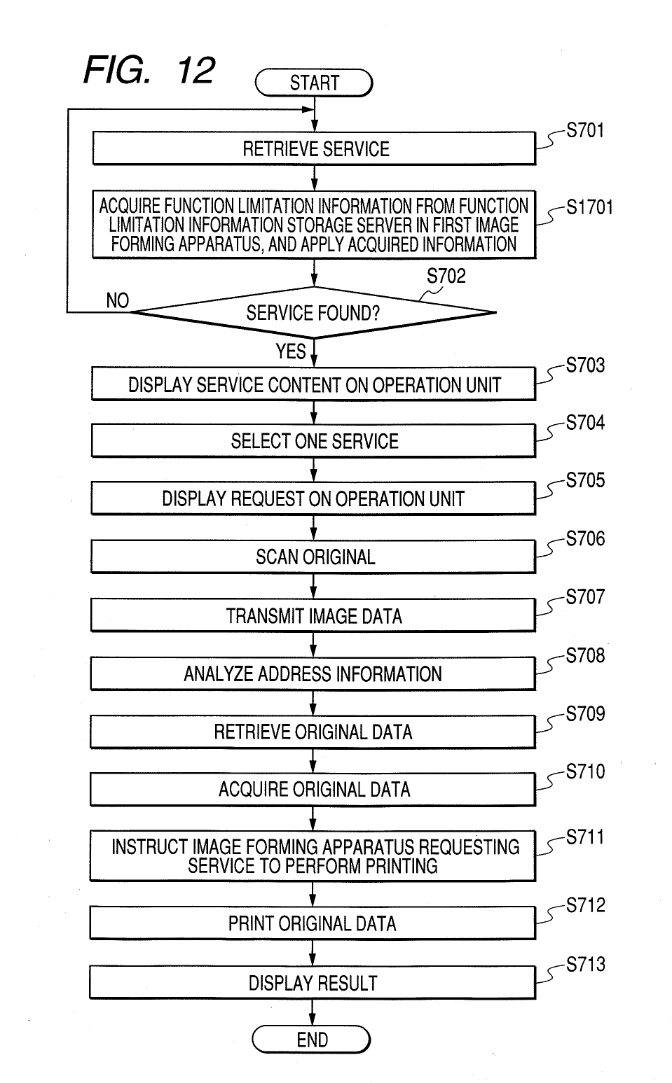

FIG. 12 is a flow chart indicating an example of a third data processing procedure in the image forming apparatus according to the third embodiment. The flow chart of FIG. 12 includes steps S701 to S713 (i.e., the process of the second image forming apparatus 101) and S1701 (i.e., the process of the first image forming apparatus 100). Incidentally, the same processes as those in the first embodiment illustrated in FIG. 9A are indicated by the same reference numerals respectively, and the description thereof will be omitted.

First, in S701, a user of the second image forming apparatus 101 performs a function retrieval request process after depressing the ID key 528 and then inputting user authentication information. Thus, a retrieval packet indicating the function retrieval request including the user authentication information is transmitted a broadcast address. Then, in S1701, the first image forming apparatus 100 acquires the function limitation information from the function limitation information storage server 1501 based on the user authentication information transmitted from the second image forming apparatus 101, and stores the acquired function limitation information in the DRAM 116 of the second image forming apparatus 101. Subsequently, the first image forming apparatus 100 returns response information on which the function limitation information acquired in regard to the retrieval request in S701 has been reflected. Incidentally, the following steps are respectively the same as the corresponding steps illustrated in FIG. 9A, whereby the description thereof will be omitted.

According to the third embodiment, the function limitation information for each user is stored in the function limitation information storage server 1501, and the stored function limitation information is acquired and used by the first image forming apparatus 100 when needed. Consequently, even in a case where the function limitation information is not prepared previously in the image forming apparatus being a service retrieval destination, the retrieval result of the function to which the latest function limitation information is applied can be acquired if the user authentication information is given from the image forming apparatus being a service retrieval source. In this case, if the function limitation information corresponding to the user authentication information received by the first image forming apparatus 100 has previously been stored in the DRAM 116, the operation for acquiring the function limitation information from the function limitation information storage server 1501 is omitted.

In any case, in the above-described first, second and third embodiments, the original data is retrieved from the HDD 162 and the document management server 102.

However, the present invention is not limited to this. Namely, the original data may be retrieved from another device connected to the image input/output system.

Further, in the above-described first, second and third embodiments, to clarify the description, the image input/output system in which one image forming apparatus having the specific function, one image forming apparatus not having the specific function, and one document management server are connected on the LAN 400 is exemplified.

However, the present invention is not limited to this. That is, the image input/output system may include at least one apparatus having a specific function. If so, the image input/output system may include plural kinds of apparatuses connected or may not include an image forming apparatus not having a specific function and/or a document server.

Further, in the case where the plural image forming apparatuses respectively having the specific function are connected on the LAN, the respective apparatuses may have the different functions or the same function.

Furthermore, in the above-described first, second and third embodiments, the retrieval request transmitted from the second image forming apparatus 101 may further include various kinds of retrieval conditions designated by the user.

Furthermore, the retrieval request process may be performed without adding any function limitation information and user authentication information to the retrieval request transmitted from the second image forming apparatus 101. In this case, the function limitation information may be reflected on the retrieval result so as to disable from selecting the limited function.

### Fourth Embodiment

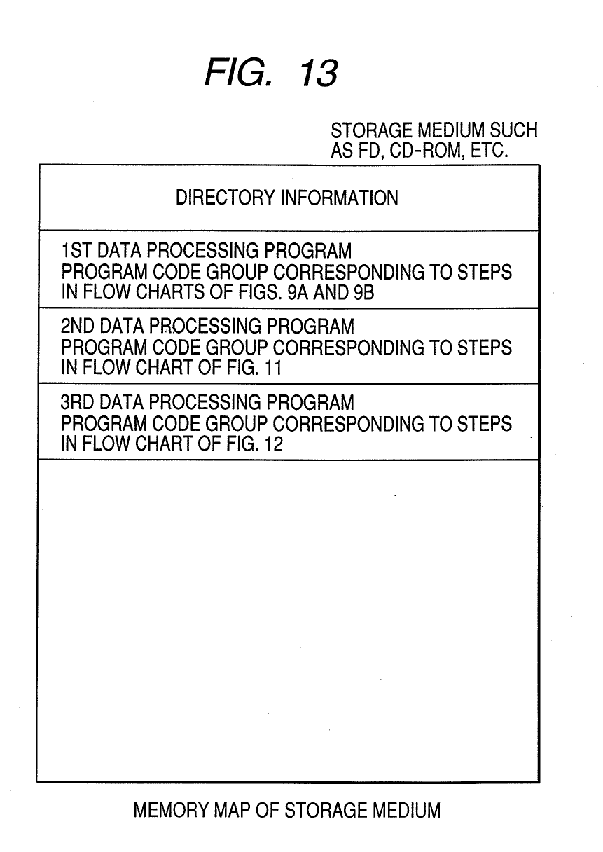

Hereinafter, the architecture of data processing programs readable by the image forming apparatus according to the present invention will be described with reference to a memory map illustrated in FIG. 13.

FIG. 13 is the diagram for describing the memory map of the storage medium which stores the various data processing programs readable by the image forming apparatus according to the present invention.

Incidentally, although it is not illustrated specifically, also information, e.g., version information, creator information, etc. for administrating the program groups stored in the storage medium may occasionally be stored in the storage medium, and information, e.g., icon information for discriminatively displaying a program, etc. depending on an OS or the like on the program reading side may occasionally be stored in the storage medium.

Further, data depending on the various programs are administrated on the directory of the storage medium. Besides, a program for installing various programs into a computer, a program for uncompressing installed programs and data when the installed programs and data have been compressed, and the like are occasionally stored.

Furthermore, the functions illustrated in FIGS. 9A, 9B, 11 and 12 may be executed by a host computer based on externally installed programs. In that case, the present invention is applicable even in a case where an information group including programs is supplied from a storage medium such as a CD-ROM, a flash memory, an FD or the like, or an external storage medium via a network to an output apparatus.

As described above, it is needless to say that the object of the present invention can be achieved in a case where the storage medium storing the program codes of software to achieve the functions of the above-described embodiments is supplied to a system or an apparatus and then a computer (or CPU or MPU) in the system or the apparatus reads and executes the program codes stored in the storage medium.

In that case, the program codes themselves read from the storage medium achieve the new functions of the present invention, whereby the storage medium storing the program codes constitutes the present invention.

Therefore, because the form of program is no object if it has an actual function as the program, an object code, a program executed by an interpreter, script data supplied to an OS, and the like may be included as the program.

As the storage medium for supplying the program, for example, a flexible disk, a hard disk, an optical disk, a magnetooptical disk, a CR-ROM, a CD-R, a CD-RW, a magnetic tape, a nonvolatile memory card, a ROM, a DVD or the like can be used.

In this case, the program codes themselves read from the storage medium achieve the functions of the above-described embodiments, whereby the storage medium storing the program codes constitutes the present invention.

Besides, as a method of supplying programs, there is a method of connecting with a website on the Internet by using a browser of a client computer, and downloading the computer program itself of the present invention or a compressed file including an automatic installing function together with the computer program into the recording medium such as a hard disk or the like. Moreover, there is a method of dividing the program codes constituting the program of the present invention into plural files and downloading the respective files from different websites. That is, a WWW server, an FTP (file transfer protocol) server and the like for downloading the program files for achieving the function processes of the present invention with use of the computer to plural users are included in the scope of the present invention.

Moreover, it is possible to encrypt the program of the present invention, store the encrypted program in a storage medium such as a CD-ROM or the like, distribute the acquired storage media to users, cause the user who has satisfied a predetermined condition to download key information for decrypting the encrypted program from the website via the Internet, cause the user in question to install the decrypted program into an appropriate computer, and thus achieve the functions of the present invention.

Moreover, it is needless to say that the present invention includes not only a case where the functions of the above-described embodiments are achieved by executing the program codes read by the computer, but also a case where an OS (operating system) or the like functioning on the computer executes a part or all of the actual process according to, e.g., instructions of the program codes, whereby the functions of the above-described embodiments are achieved by that process.

Furthermore, it is needless to say that the functions of the above-described embodiments can be achieved in a case where the program read from the storage medium is once written in a memory provided in a function expansion board inserted in the computer or a function expansion unit connected to the computer, and then a CPU or the like provided in the function expansion board or the function expansion unit executes a part or all of the actual process according to the instructions of the program.

While the present invention has been described with reference to what is presently considered to be the preferred embodiments, it is to be understood that the invention is not limited to the disclosed embodiments. On the contrary, the present invention is intended to cover various modifications and equivalent arrangements (including the organic combination of respective embodiments) included within the spirit and scope of the appended claims. The scope of the following claims is to be accorded the broadest interpretation so as to encompass all such modifications and equivalent structures and functions.

Although the embodiment has been explained by way of various examples, it is apparent for one of ordinary skill in the art that the purpose and the scope of the present invention are not limited to the specific explanations described in the present application.

This application claims priority from Japanese Patent Application No. 2007-096567 filed Apr. 2, 2007, which is hereby incorporated by reference herein.

What is claimed is:

1. An information processing apparatus capable of communicating with another device, comprising:
a setting unit adapted to set function limitation information for individual user;
a retrieval unit adapted to issue a function retrieval request for the another device with the function limitation information for individual user set by the setting unit added;
an acquisition unit adapted to acquire response information for the function retrieval request issued by the retrieval unit; and
a display unit adapted to display an acquisition result by the acquisition unit.

2. An information processing apparatus according to claim 1, wherein the display unit displays a list of functions, from among the functions of another device, according to the response information.

3. An information processing apparatus according to claim 1, wherein the setting unit sets the function limitation information for individual user previously stored in the information processing apparatus.

4. An information processing apparatus according to claim 1, wherein the setting unit acquires and sets the function limitation information for individual user from a server.

5. An information processing apparatus according to claim 1, further comprising a unit adapted to, in a case where a function limited by the function limitation information is included in the response information acquired by the acquisition unit, disable from selecting the limited information.

6. An information processing apparatus capable of communicating with another device, comprising:
an acquisition unit adapted to acquire user authentication information added to a function retrieval request transferred from the another device; and
a response unit adapted to generate response information to the function retrieval request according to function limitation information for individual user acquired from a server based on the user authentication information acquired by the acquisition unit, and respond to the function retrieval request by the generated response information.

7. An information processing apparatus according to claim 6, wherein, in a case where the function limitation information is included in the function retrieval request, the response unit generates the response information according to the function limitation information.

8. An information processing apparatus according to claim 6, wherein, in a case where the function limitation information of a user corresponding to the user authentication information acquired by the acquisition unit has been previously stored, the response unit generates the response information according to the function limitation information.

9. A function limitation method in an information processing apparatus capable of communicating with another device, the method comprising:
a setting step of setting function limitation information for individual user;
a retrieval step of issuing a function retrieval request for the another device with the function limitation information for individual user set in the setting step added;
an acquisition step of acquiring response information for the function retrieval request issued in the retrieval step; and
a display step of controlling a display to display an acquisition result in the acquisition step.

10. A function limitation method according to claim 9, wherein the display step controls the display to display a list of functions, from among the functions of another device, according to the response information.

11. A function limitation method according to claim 9, wherein the setting step sets the function limitation information for individual user previously stored in the information processing apparatus.

12. A function limitation method according to claim 9, wherein the setting step acquires and sets the function limitation information for individual user from a server.

13. A function limitation method according to claim 9, further comprising a step of, in a case where a function limited by the function limitation information is included in the response information acquired in the acquisition step, disabling from selecting the limited information.

14. A function limitation method in an information processing apparatus capable of communicating with another device, the method comprising:
an acquisition step of acquiring user authentication information added to a function retrieval request transferred from the another device; and
a response step of generating response information to the function retrieval request according to function limitation information for individual user acquired from a server based on the user authentication information acquired in the acquisition step, and responding to the function retrieval request by the generated response information.

15. A function limitation method according to claim 14, wherein, in a case where the function limitation information is included in the function retrieval request, the response step generates the response information according to the function limitation information.

16. A function limitation method according to claim 14, wherein, in a case where the function limitation information of a user corresponding to the user authentication information acquired in the acquisition step has been previously stored, the response step generates the response information according to the function limitation information.
